(19) United States
(12) Patent Application Publication
(10) Pub. No.: US 2021/0371618 A1
(43) Pub. Date: Dec. 2, 2021

(54) GRAPHENE DISPERSION AND METHOD FOR PREPARING THE SAME

(71) Applicant: Far Eastern New Century Corporation, Taipei City (TW)

(72) Inventors: Yu-Chun Wu, Taipei City (TW); Wei-Che Hung, Taipei City (TW); Chun-Chieh Chien, Taipei City (TW)

(21) Appl. No.: 17/187,153

(22) Filed: Feb. 26, 2021

(30) Foreign Application Priority Data
May 26, 2020 (TW) 109117456

(51) Int. Cl. C08K 3/04; C01B 32/194; C01B 32/19; C08J 3/205; C08J 3/215

(52) U.S. Cl. CPC C08K 3/042; C01B 32/194; C01B 32/19; C01P 2002/86; C08J 3/215; C01B 2204/28; C08K 2201/011; C08J 3/2053

(57) ABSTRACT

A graphene dispersion includes a graphene and a polyol compound selected from the group consisting of an aromatic polyol represented by Formula (I), and a modified aromatic polyol made by subjecting the aromatic polyol represented by Formula (I) and an epoxidized vegetable oil to a ring opening reaction,

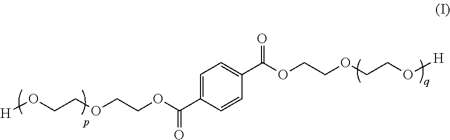

wherein p and q are independently integers ranging from 1 to 20. A method for preparing the graphene dispersion, a composition for preparing a polyurethane composite material, and a polyurethane composite material made from the composition are also disclosed.

### CROSS-REFERENCE TO RELATED APPLICATION

This application claims priority of Taiwanese Invention Patent Application No. 109117456, filed on May 26, 2020.

### FIELD

This disclosure relates to a graphene dispersion, a method for preparing the same, and applications thereof, and more particularly to a graphene dispersion made from an aromatic polyol, a method for preparing the same, and applications thereof.

### BACKGROUND

Graphene is a material having various advantages such as high carrier mobility, high hardness, good thermal conductivity, high current-carrying capacity, etc., and has been widely used in electronic or optoelectronic devices, biomedical applications, and so on.

Conventionally, graphene might be prepared by a physical process (e.g., mechanical exfoliation, ultrasonic exfoliation, etc.) or a chemical process (e.g., chemical vapor deposition, oxidation-reduction reaction, etc.). For example, Taiwanese Patent No. TW 1655154 discloses a method of manufacturing a graphene material, which includes complicated steps, i.e., two oxidation steps, three heating steps, a separation step, a drying step, a reduction step, and so on. The two oxidation steps employ different oxidants. Alternatively, U.S. Pat. No. 7,658,901 discloses a modified graphite oxide material including a thermally exfoliated graphite oxide and a method for manufacturing the same. The method includes the steps of oxidizing graphite and heating the graphite oxide at a temperature as high as 1050° C. to allow decomposition and expansion thereof, which requires expensive equipment and consumes a large amount of energy.

For the convenience of subsequent applications, graphene are commonly made into graphene dispersions to prevent agglomeration due to π-π conjugation and Van der Waals force formed among graphene interlayers.

Taiwanese Patent No. TW 1636954 discloses a graphene dispersion and a preparation method thereof. The method includes a homogenization process of graphene powders and a processing solvent to form a graphene paste, followed by a layer-thinning process of the graphene paste to form a graphene dispersion. Although the method might increase solid content and dispersibility of graphene in the graphene dispersion, a large amount of solvent (e.g., xylene, isopropanol, butyl acetate, N-methylpyrrolidone, etc.) is required during the homogenization process, which might not be favorable for subsequent applications and might cause pollution. A method for preparing a graphene dispersion as disclosed in Dan Li et al., “Processable dispersions of graphene nanosheets,” Nature Nanotechnology (2008), vol. 3, pages 101-105, includes subjecting graphite oxide to a reduction reaction with hydrazine hydrate so as to obtain stable aqueous graphene dispersion. This method uses water as a solvent and requires addition of ammonia water during the manufacturing process, which might limit applications of the resultant graphene dispersion.

Alternatively, besides solvents, dispersants are often used for preparing graphene dispersions. For example, Taiwanese Patent No. TW 1602611 discloses a graphene dispersant, which includes an aniline oligomer or derivative thereof. By addition of the graphene and the graphene dispersant into a solvent, a π-π bond is formed between the graphene and the graphene dispersant. Examples of the solvent may include water, organic solvent (e.g., ethanol, acetone, isopropanol, butanol, ethyl acetate, toluene, chloroform, etc.), polymeric material, and combinations thereof. Because the solvent might include water or organic solvent, the graphene dispersions made by this method might not be suitable for subsequent applications and might cause pollution.

In addition, surface treatment is also a commonly used technique for increasing dispersibility of graphene. For example, Japanese Patent Publication No. JP 2015520109A discloses a graphene powder which includes a compound having a catechol group serving as a surface-treating agent. The graphene powder with surface treated by the catechol group might be prone to oxidation since the catechol group has relatively unstable electrochemical properties. As another example, U.S. Patent Publication No. US 20190322789 A1 discloses a polyurethane including reaction product of an isocyanate component, a polyol component, and graphene nano platelets. The graphene nano platelets might be an oxidized form of graphene (i.e., graphene functionalized with oxygen-containing groups) or an amine-substituted graphene for increasing dispersibility thereof.

Further, U.S. Patent Publication No. US 2019051903 A1 discloses a surface-treated graphene obtained by mixing graphene oxide with a surface treatment agent (including a phenyl-contained compound), and subjecting the graphene oxide to a reduction treatment. This method requires removal of organic solvents from the thus formed graphene dispersion and specific drying techniques such as spray drying and freeze drying, which complicates a manufacturing process thereof, and might cause pollution during removal of the organic solvents.

Based on the aforesaid, there is still a need to develop a graphene dispersion which does not require the usage of a conventional organic solvent, and which has an increased solid content of graphene and an improved dispersion stability.

One solution is to use a polyol in replacement of the organic solvent. The polyol can be hydrophilic or hydrophobic according to practical needs in subsequent applications. Conventional polyols are generally hydrophilic, and known hydrophobic polyols have been used only for preparation of polyurethane materials. For example, Chinese Patent Publication No. CN 101195577A discloses a method for preparing a hydrophobic polyol, which subjects a mixed liquid including an epoxidized soybean oil, alcohol, and water to a ring-opening reaction in the presence of an acidic or basic catalyst. As another example, U.S. Pat. No. 7,393,465 discloses a process for preparing a hydrophobic polyol, which includes a step of reacting a mixture including cardanol, cardol, and 6-methylcardol with at least one alkylene oxide. The hydrophobic polyols disclosed in the abovementioned references are used for preparation of polyurethane materials, rather than that of graphene dispersion.

In addition, in view of graphene having excellent properties in hardness, thermal conductivity, and so on, graphene may also be used for preparing a polyurethane composite material. Conventional methods for preparing the polyurethane composite material generally require addition of a graphene dispersion into a polyurethane solution or a polyurethane melt. The graphene dispersion normally includes a solvent (e.g., xylene, isopropanol, butyl acetate, N-methylpyrrolidone) or a dispersant (e.g., aniline) for dispersing the graphene. The use of the solvent or dispersant might adversely affect properties of the polyurethane composite material and might also cause environmental pollution.

### SUMMARY

Therefore, a first object of the disclosure is to provide a graphene dispersion that can alleviate or eliminate at least one of the drawbacks of the prior art. A second object of the disclosure is to provide a method for preparing the graphene dispersion. A third object of the disclosure is to provide a composition for preparing a polyurethane composite material. A fourth object of the disclosure is to provide a polyurethane composite material.

According to a first aspect of the disclosure, a graphene dispersion includes a graphene and a polyol compound. The polyol compound is selected from the group consisting of an aromatic polyol represented by Formula (I), and a modified aromatic polyol made by subjecting the aromatic polyol represented by Formula (I) and an epoxidized vegetable oil to a ring opening reaction,

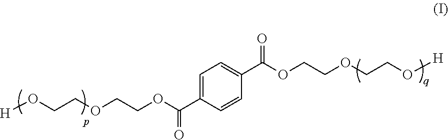

wherein p and q are independently integers ranging from 1 to 20. According to a second aspect of the disclosure, a method for preparing a graphene dispersion includes the steps of:

a) mixing an expanded graphite and a polyol compound to obtain a mixture, the polyol compound being selected from the group consisting of the aromatic polyol represented by Formula (I) and the modified aromatic polyol made by subjecting the aromatic polyol represented by Formula (I) and an epoxidized vegetable oil to a ring opening reaction,

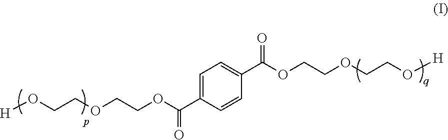

in which p and q are independently integers ranging from 1 to 20; and

b) subjecting the mixture to a mechanical process so as to exfoliate the expanded graphite to obtain the graphene dispersion.

According to a third aspect of the disclosure, a composition for preparing a polyurethane composite material includes the graphene dispersion and a curing compound having at least two isocyanate groups.

According to a fourth aspect of the disclosure, a polyurethane composite material is made from the composition.

The aromatic polyol represented by Formula (I) and the modified aromatic polyol made thereby may increase a dispersibility of graphene in the graphene dispersion. This is because the phenyl groups in the aromatic polyol represented by Formula (I) and the modified aromatic polyol can form π-π bonds with the graphene to prevent formation of π-π conjugation and Van der Waals force among graphene interlayers, and thus agglomeration and precipitation of the graphene may be avoided. In addition, the aromatic polyol represented by Formula (I) and the modified aromatic polyol exhibit excellent reactivities, and thus may serve as reactive agents and improve a compatibility between the graphene dispersion and organic materials used in subsequent applications (e.g., preparation of a polyurethane product). Therefore, the graphene dispersion of the disclosure may have wider application, and solvents or other reactive additives for dispersing the graphene may not be required during the preparation process of the polyurethane product. The thus prepared polyurethane product may exhibit improved properties such as abrasion resistance and antistatic property.

Further, since water and organic solvents are not required during the preparation process of the polyurethane composite material of the disclosure, a heating step for removing the solvents can be omitted, thereby reducing energy consumption and manufacturing cost thereof. Furthermore, the graphene dispersion prepared from the method of the disclosure can be used directly in subsequent applications without further processing, which is more convenient compared to conventional preparation methods of graphene powders.

### BRIEF DESCRIPTION OF THE DRAWINGS

Other features and advantages of the disclosure will become apparent in the following detailed description of the embodiment(s) with reference to the accompanying drawings, in which:

FIG. 1 is a nuclear magnetic resonance (NMR) spectrum illustrating a result of a structural analysis conducted on an aromatic polyol of Preparative Example A3 according to the disclosure.

### DETAILED DESCRIPTION

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described. For clarity, the following definitions are used herein.

<Graphene Dispersion>

According to the disclosure, an embodiment of a graphene dispersion includes a graphene and a polyol compound.

The type of graphene in the graphene dispersion is not specifically limited. In an embodiment, the graphene is an unmodified graphene on surfaces of which functional groups for surface modification (e.g., oxygen-containing groups or amino group) are not attached. In an embodiment, the graphene is present in an amount ranging from 1 wt % to 20 wt % based on a total weight of the graphene dispersion. In another embodiment, the graphene is present in an amount ranging from 3 wt % to 10 wt % based on the total weight of the graphene dispersion. In an embodiment, the graphene dispersion has a viscosity that ranges from 5000 cP to 40000 cP at 30° C. In another embodiment, the graphene dispersion has a viscosity that ranges from 5000 cP to 30000 cP at 30° C. In still another embodiment, the graphene dispersion has a viscosity that ranges from 5000 cP to 25000 cP at 30° C.

The polyol compound is selected from the group consisting of an aromatic polyol represented by Formula (I), and a modified aromatic polyol made by subjecting the aromatic polyol represented by Formula (I) and an epoxidized vegetable oil to a ring opening reaction,

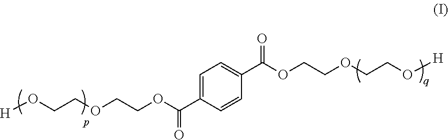

wherein p and q are independently integers ranging from 1 to 20. In an embodiment, p and q are independently integers ranging from 2 to 15. In another embodiment, p and q are independently integers ranging from 3 to 10.

In an embodiment, the aromatic polyol represented by Formula (I) has a viscosity that ranges from 800 cP to 1500 cP at 30° C. In another embodiment, the aromatic polyol represented by Formula (I) has a viscosity that ranges from 900 cP to 1200 cP at 30° C.

The aromatic polyol represented by Formula (I) may be prepared by any process well-known in the art, for example, but is not limited to, reacting ethylene oxide (hereinafter abbreviated as EO) with bis(2-hydroxyethyl) terephthalate [hereinafter abbreviated as BHET]. BHET may be prepared by reacting terephthalic acid (TPA) and EO and is represented by the following formula:

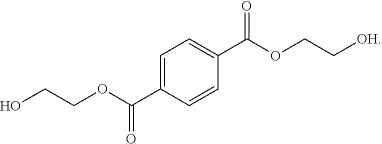 [SMILES: O=C(OCCO)c1ccc(C(=O)OCCO)cc1]

In an embodiment, a ratio of a molar amount of EO to a molar amount of BHET is not smaller than 4.

When the polyol compound is the modified aromatic polyol, amounts of the aromatic polyol represented by Formula (I) and the epoxidized vegetable oil used may be adjusted according to properties of the aromatic polyol represented by Formula (I) or according to desired properties of the modified aromatic polyol. In an embodiment, the amount of the epoxidized vegetable oil used ranges from 5 parts by weight to 150 parts by weight based on 100 parts by weight of the aromatic polyol used. In another embodiment, the amount of the epoxidized vegetable oil used ranges from 20 parts by weight to 100 parts by weight based on 100 parts by weight of the aromatic polyol used. Examples of the epoxidized vegetable oil may include, but are not limited to, epoxidized soybean oil, epoxidized sunflower oil, epoxidized olive oil, epoxidized corn oil, epoxidized peanut oil, epoxidized canola oil, and combinations thereof. In this embodiment, the epoxidized soybean oil is used to modify the aromatic polyol.

In an embodiment, the modified aromatic polyol has a viscosity ranging from 400 cP to 1500 cP. In another embodiment, the modified aromatic polyol has a viscosity ranging from 1000 cP to 1500 cP.

In an embodiment, the modified aromatic polyol has a moiety represented by Formula (II) (hereinafter referred to as TPA moiety) that is present in an amount ranging from 5 wt % to 18 wt % based on a total weight of the modified aromatic polyol

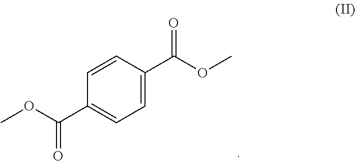

In another embodiment, the TPA moiety is present in an amount ranging from 6 wt % to 14 wt % based on the total weight of the modified aromatic polyol. When the TPA moiety is present in an amount lower than 5 wt %, the dispersion stability of the graphene dispersion made from the modified aromatic polyol may be adversely affected after a long period of storage.

The modified aromatic polyol may be prepared by subjecting epoxy compounds to any ring opening reaction that is well-known in the art. For example, the modified aromatic polyol may be prepared by the abovementioned process of subjecting the aromatic polyol represented by Formula (I) and the epoxidized vegetable oil to the ring opening reaction. In an embodiment, the ring opening reaction is implemented at a temperature ranging from 80° C. to 250° C. In another embodiment, the ring opening reaction is implemented at a temperature ranging from 100° C. to 200° C. To be specific, the aromatic polyol represented by Formula (I) is first mixed with the epoxidized vegetable oil to obtain a mixture, and then the mixture is subjected to the ring opening reaction to obtain the modified aromatic polyol. In an embodiment, the ring opening reaction is implemented until a conversion ratio of the aromatic polyol reaches 99% or above. The conversion ratio is calculated by the following formula:

$$conversion ratio = ( 1 - \frac{1}{\frac{EEW 2}{EEW 1}} ) \times 100 \% ,$$

in which EEW1 is an epoxy equivalent weight of the mixture or a theoretical epoxy equivalent weight required to react with the hydroxyl groups of the aromatic polyol, and EEW2 is an epoxy equivalent weight of the modified aromatic polyol. In this embodiment, when the amount of epoxidized soybean oil (i.e., epoxidized vegetable oil) used is lower than 80 parts by weight based on 100 parts by weight of the aromatic polyol used, EEW1 is taken as the epoxy equivalent weight of the mixture. When the amount of the epoxidized soybean oil used is not lower than 80 parts by weight, EEW1 is taken as the theoretical epoxy equivalent weight required to react with the hydroxyl groups of the aromatic polyol.

The aromatic polyol represented by Formula (I) or the modified aromatic polyol exhibits excellent reactivity, dispersibility, and low viscosity. The reactivity means that the aromatic polyol or the modified aromatic polyol may react with a curing agent (e.g., a compound having isocyanate groups) to become a part of a thus formed product. The dispersibility means that the aromatic polyol or the modified aromatic polyol may have ability for dispersing the graphene in the graphene dispersion. This is because the aromatic polyol or the modified aromatic polyol includes a relatively high weight percentage of phenyl group. The phenyl group can form π-π bonds with the graphene to prevent formation of π-π conjugation and Van der Waals force among graphene interlayers, and thus agglomeration and precipitation of the graphene may be avoided. Further, since the aromatic polyol or the modified aromatic polyol has relatively low viscosity, additional viscosity-reducing agents are not required during a grinding process of a precursor for forming the graphene dispersion, thereby simplifying the preparation process of the graphene dispersion and making the process more environmentally friendly. Furthermore, when the polyol compound is the modified aromatic polyol, the graphene dispersion may have a relatively high dispersion stability for storage since the hydrophobicity of the modified aromatic polyol may reduce water absorption of the graphene dispersion.

Moreover, when a conventional graphene dispersion has a relatively high solid content of graphene, the viscosity thereof may be largely increased due to stronger π-π conjugation and Van der Waals force formed among the graphene interlayers. Therefore, the solid contents of graphene in conventional graphene dispersions are usually controlled to be relatively low, otherwise the graphene dispersions might be difficult to use. In comparison, in the present disclosure, formation of π-π bonds among the graphene and the phenyl groups in the aromatic polyol or the modified aromatic polyol may prevent formation of π-π conjugation and Van der Waals force among the graphene interlayers. Therefore, the graphene dispersion of this disclosure can maintain a relatively low viscosity even when having a relatively high solid content of graphene.

As such, the graphene dispersion of this disclosure is suitable for use in the preparation of various products, such as a biomedical product, a coating product, an electronic or photoelectronic product, a polyurethane (PU) artificial leather product, etc. During the preparation processes of these products, a step of removing the solvent may be omitted, which may simply the processes, lower the manufacture costs thereof, and prevent environmental hazards.

<Method for Preparing the Graphene Dispersion>

According to the disclosure, an embodiment of a method for preparing the graphene dispersion includes the steps of:

a) mixing an expanded graphite and the polyol compound to obtain a mixture, the polyol compound being selected from the group consisting of the aromatic polyol represented by Formula (I) and the modified aromatic polyol made by subjecting the aromatic polyol represented by Formula (I) and the epoxidized vegetable oil to the ring opening reaction; and

b) subjecting the mixture to a mechanical process to exfoliate the expanded graphite so as to obtain the graphene dispersion.

In an embodiment, in step a), the aromatic polyol represented by Formula (I) or the modified aromatic polyol is stirred to generate a turbulent flow, and then the expanded graphite is added to mix with the aromatic polyol. To be specific, step a) may be divided into two sub-steps of:

1) placing the aromatic polyol represented by Formula (I) or the modified aromatic polyol in a beaker, and then mixing the content of the beaker using an electric mixer; and

2) adding the expanded graphite into the beaker and mixing the content of the beaker.

The mechanical process in step b) involves physical processing of the mixture using tools or machines, and may be any process suitable for exfoliation of the expanded graphite. Examples of the mechanical process may include, but are not limited to, mechanical exfoliation, grinding, ultrasonic exfoliation, three roll milling, ball mill mixing, shear mixing, high speed homogenizing, high pressure homogenizing, and combinations thereof.

In order to ensure the expanded graphite is transformed completely into graphene, a length of time the mixture is subjected to the mechanical process can be extended until a conversion rate of the expanded graphite (or other graphene precursors) reaches 99% or above. As such, a desired solid content of the graphene in the graphene dispersion may be achieved.

In an embodiment, before step a), the method further includes a step a1) of reacting BHET with EO to obtain the aromatic polyol represented by Formula (I), in which a ratio of the molar amounts of EO and BHET is not smaller than 4.

<Composition for Preparing a Polyurethane Composite Material>

According to the disclosure, an embodiment of a composition for preparing a polyurethane composite material includes a graphene, an aromatic polyol selected from one of the aromatic polyol represented by Formula (I) and the modified aromatic polyol, and a curing compound having at least two isocyanate groups. In this embodiment, the polyurethane composite material includes the graphene dispersion of the disclosure and a curing compound having at least two isocyanate groups.

Examples of the curing compound having at least two isocyanate groups may include, but are not limited to, isophorone diisocyanate (IPDI), toluene diisocyanate (TDI), methylenediphenyl diisocyanate (MDI), dicyclohexylmethane diisocyanate (HMDI), polyisocyanate (e.g., No. SC-7190NY purchased from Evermore Chemical Industry Co., Ltd.), hydrogenated diphenylmethane 4,4-diisocyanate, polymethylene polyphenyl isocyanate (PAPI), and combinations thereof.

Amounts of the graphene dispersion and the curing compound in the composition for preparing the polyurethane composite material are not specifically limited, and may be adjusted according to practical requirements. In an embodiment, the curing compound is present in an amount ranging from 5 parts by weight to 100 parts by weight based on 100 parts by weight of the graphene dispersion. In another embodiment, the curing compound is present in an amount ranging from 6 parts by weight to 87 parts by weight based on 100 parts by weight of the graphene dispersion.

In an embodiment, the composition further includes a polyurethane which is in absence of a solvent therein. An amount of the graphene dispersion may range from 1 parts by weight to 20 parts by weight based on 30 parts by weight of the polyurethane.

In another embodiment, the composition is in absence of a solvent therein.

In still another embodiment, the composition further includes a polyurethane slurry including a polyurethane and a solvent. An amount of the graphene dispersion may range from 1 parts by weight to 20 parts by weight based on 30 parts by weight of the polyurethane in the polyurethane slurry.

As used herein, the term “solvent” refers to a substance which can be used as a dispersant, and which is unreactive with components of the composition for preparing the polyurethane composite material. That is, the solvent should be unreactive with the graphene, the aromatic polyol, and the curing compound having at least two isocyanate groups. Examples of such solvent may include, but are not limited to, dimethylformamide (DMF), toluene, xylene, acetone, butanone (MEK), ethyl acetate, and propylene glycol monomethyl ether acetate (PGMEA).

<Polyurethane Composite Material>

According to the disclosure, an embodiment of a polyurethane composite material is made from the abovementioned composition. To be specific, the aromatic polyol in the composition may be reacted with the curing compound to form the polyurethane composite material. In an embodiment, the graphene is present in the polyurethane composite material in an amount ranging from 0.1 wt % to 8 wt % based on a total weight of the polyurethane composite material. In another embodiment, the graphene is present in an amount ranging from 0.2 wt % to 5 wt % based on the total weight of the polyurethane composite material. In still another embodiment, the graphene is present in an amount ranging from 0.25 wt % to 2 wt % based on the total weight of the polyurethane composite material.

The disclosure will be further described by way of the following examples. However, it should be understood that the following examples are solely intended for the purpose of illustration and should not be construed as limiting the disclosure in practice.

### EXAMPLES

### Preparation of BHET

264.3 g (1.59 mol) of terephthalic acid, 2.9 g of sodium carbonate, and 158.5 g of water were added into a 1 L stainless steel reactor. The content of the stainless steel reactor was stirred and heated to a temperature of 120° C., and then 245.2 g (5.57 mol) of EO was gradually added into the stainless steel reactor at a flow rate of 1 mL/min whilst keeping the stainless steel reactor under a temperature of 120° C. and a pressure of not greater than 7.0 kgf/cm² for generating a reaction. After performing the reaction for 15 minutes, the stainless steel reactor was cooled to a temperature of 110° C., and then water was removed using reduced pressure distillation. Finally, the stainless steel reactor was cooled to room temperature to obtain BHET.

### Preparation of Aromatic Polyol Represented by Formula (I)

### Preparative Example A1

300 g (1.18 mol, 100 parts by weight) of BHET as prepared above and 0.05079 g (100 ppm) of potassium hydroxide (KOH) were added into a reaction tank and heated to a temperature of 130° C. under a pressure of 9.0 kgf/cm². After BHET was melted at 130° C., 207.99 g (4.73 mol, 69.3 parts by weight) of EO was gradually added into the reaction tank at a flow rate of 1 mL/min. Subsequently, the content of the reaction tank was mixed at 500 rpm to be reacted for 0.5 hour so as to obtain the aromatic polyol of Preparative Example A1 (also referred to as PHB4).

### Preparative Examples A2 to A7 and Comparative Preparation Example A1

The procedures and conditions for preparing the aromatic polyols of Preparative Examples A2 to A7 and Comparative Preparation Example A1 (also referred to as PHB6, PHB10, PHB11, PHB20, PHB25, PHB30, and PHB40, respectively) were similar to those for preparing PHB4 (i.e., the aromatic polyol of Preparative Example A1), except that the amount of EO added in each of PHB6 to PHB40 was varied as recorded in Table 1.

TABLE 1

| | | | Amount of EO added | | |
|---|---|---|---|---|---|
| | | | | | Parts by |
| | | Aromatic polyol | g | mol | weight |
| Preparative | A1 | PHB4 | 207.99 | 4.73 | 69.3 |
| Example | A2 | PHB6 | 311.85 | 7.08 | 104.0 |
| | A3 | PHB10 | 519.75 | 11.80 | 173.3 |
| | A4 | PHB11 | 572.00 | 13.00 | 190.5 |
| | A5 | PHB20 | 1039.50 | 23.60 | 346.5 |
| | A6 | PHB25 | 1298.38 | 29.48 | 433.0 |
| | A7 | PHB30 | 1559.25 | 35.40 | 519.9 |

| | | | | |
|---|---|---|---|---|
| Comparative | PHB40 | 2079.00 | 47.20 | 693.0 |
| Preparation | | | | |
| Example A1 | | | | |

### Evaluations of the Aromatic Polyol Represented by Formula (I):

1. State of Matter

The aromatic polyol of each of Preparative Examples A1 to A7 and Comparative Preparation Example A1 was observed to determine a state of matter under room temperature. The results are presented in Table 2.

2. Viscosity (cP)

The viscosity of the aromatic polyol of each of Preparative Examples A1 to A7 and Comparative Preparation Example A1 was measured using a digital viscometer (Manufacturer: Brookfield; Model: DV-E) under a temperature of 30° C. The results are presented in Table 2.

3. Molecular Weight

The molecular weight of the aromatic polyol of each of Preparative Examples A1 to A7 and Comparative Preparation Example A1 was determined using a mass spectrometer (Manufacturer: Waters Corporation; Model: Xevo TQ-GC). The results are presented in Table 2.

4. Amount of TPA Moiety (Wt %)

The amount of TPA moiety in the aromatic polyol of each of Preparative Examples A1 to A7 and Comparative Preparation Example A1 was analyzed as follows. First, a predetermined amount of the aromatic polyol was placed in a sample bottle. Then, a predetermined amount of KOH aqueous solution with a predetermined concentration was added into each of the sample bottle containing the aromatic polyol (i.e., experimental group) and an empty bottle (i.e., control group without the aromatic polyol). Next, each of the experimental group and the control group was heated to 95° C. and stirred for 3 hours, followed by titrating with a 1 N hydrochloric acid aqueous solution. The titration amount of hydrochloric acid for each of the experimental group and the control group was recorded, which was then used to determine the amount of KOH used to react with the aromatic polyol in the experimental group and the amount of KOH in the control group. Subsequently, a saponification value of the aromatic polyol was calculated by subtracting the amount of KOH in the control group from the amount of KOH used in the experimental group. Finally, a molar amount and a weight percentage of the TPA moiety in the aromatic polyol were calculated using the following formulas:

$$the molar amount of TPA = \frac{saponification value \times ( 1 g / 1 \; 000 mg )}{56.1} \div 2 ;$$

$$the weight percentage of TPA = \frac{the molar amount of TPA \times molecular weight of TPA}{total weight of the aromatic polyol} .$$

The results are presented in Table 2.

5. Nuclear Magnetic Resonance (NMR) Spectroscopy Analysis

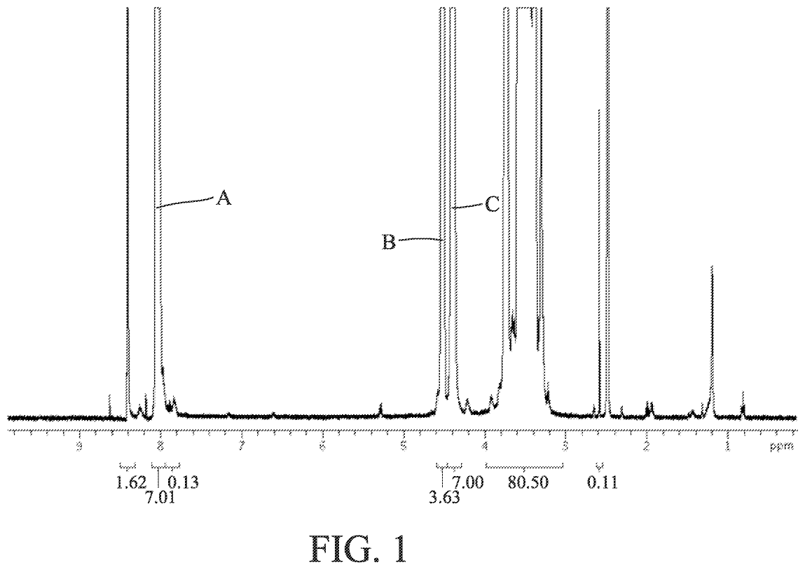

The aromatic polyol of Preparative Example A3 (PHB10) was analyzed using a ¹H-nuclear magnetic resonance (NMR) spectrometer (solvent: DMSO-d6; frequency: 400 MHz). The resultant NMR spectrum is shown in FIG. 1.

6. Gel Permeation Chromatography (GPC) Analysis

After saponification of the aromatic polyol represented by Formula (I), first and second compounds represented below were obtained:

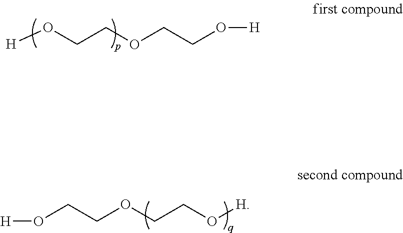

The first and second compounds are derived respectively from two terminal segments of the aromatic polyol. The weight-average molecular weight (Mw) and number-average molecular weight (Mn) of the first and second compounds obtained in each of Preparative Example A3 (PHB10), Preparative Example A4 (PHB11), and Preparative Example A5 (PHB20) were analyzed using a gel permeation chromatography (GPC) system (Manufacturer: Waters Corporation; Model: waters 1525; equipped with a refractive index detector and an aqueous column, Tsk-gel G2500PWXL). To be specific, the aromatic polyol was first subjected to a saponification reaction by reacting with a predetermined amount and predetermined concentration of sodium hydroxide aqueous solution at 95° C. while stirring for 3 hours. The resultant reaction product includes the first and second compounds which are each polyethylene glycol (PEG), and which were dissolved in water phase. After filtration with a filter paper and a screen filter, the filtrate containing the PEG was analyzed using the GPC system to estimate approximate p and q values of the abovementioned first and second compounds. Mw and Mn of the first and second compounds were calculated based on the p and q values. The results are presented in Table 3.

TABLE 2

| | | | Evaluations | | | |
|---|---|---|---|---|---|---|
| | | | | Amount of | State of matter | |
| | | | Molecular | TPA moiety | under room | Viscosity at |
| Aromatic polyol | | | weight | (wt %) | temperature | 30° C. (cP) |
| Preparative | A1 | PHB4 | 430 | 38.6 | Liquid | 1196 |
| Example | A2 | PHB6 | 518 | 32.0 | Liquid | 1115 |
| | A3 | PHB10 | 694 | 24.0 | Liquid | 1005 |
| | A4 | PHB11 | 738 | 22.2 | Liquid | 1009 |
| | A5 | PHB20 | 1134 | 14.6 | Liquid | 1062 |
| | A6 | PHB25 | 1354 | 12.3 | Liquid | 1075 |
| | A7 | PHB30 | 1574 | 11.8 | Liquid | 1093 |

| | | | | | |
|---|---|---|---|---|---|
| Comparative | PHB40 | 2014 | 8.2 | Solid | Not |
| Preparation | | | | | measureable |
| Example A1 | | | | | |

Generally, formation of precipitation in the aromatic polyol appears with the increasing amount of TPA moiety (i.e., the weight percentage of phenyl group) therein. When the aromatic polyol includes a relatively high amount of the TPA moiety, a fluidity of the aromatic polyol may be negatively affected, which may cause difficulty for use in subsequent applications. On the other hand, although an increase in the amount of EO added during preparation of the aromatic polyol may decrease a viscosity thereof, aromatic polyols formed with a relatively high amount of EO is prone to solidify when affected by temperature. Therefore, it can be observed from Table 2 that PHB40, which was prepared with EO and BHET at a ratio of molar amounts of 40:1, is in solid state under room temperature due to a relatively high amount of EO added, and is thus unsuitable as a dispersant for dispersing graphene. In comparison, the aromatic polyols of Preparative Examples A1 to A7 are in liquid state under room temperature and include the TPA moiety in suitable amounts, and are thus suitable as a dispersant for dispersing graphene.

TABLE 3

| | | GPC analysis: first and second compounds | | |
|---|---|---|---|---|
| Preparative | Aromatic | | | Polydispersity index |
| Example | polyol | Mw | Mn | (PDI = Mw/Mn) |
| A3 | PHB10 | 271 | 304 | 1.1216 |
| A4 | PHB11 | 342 | 314 | 1.0892 |
| A5 | PHB20 | 518 | 488 | 1.0583 |

Taking PHB10 as an example for detailed explanation, the molar ratio of EO to BHET used for preparing PHB10 is 10:1, and assuming that EO is evenly distributed to react with terminal hydroxyl groups of BHET, a number of terminal EO segments attached to each side of the aromatic polyol (i.e., p and q) should be 5. Therefore, a theoretical molecular weight of each of the first and second compounds is estimated to be 282 (=5×44+44+18). The Mw and Mn values of the first and second compounds of PHB10 are very close to the theoretical molecular weight of 282. In addition, since the PDI of PHB10 is 1.1216, it can be concluded that p and q values of PHB10 are extremely close to each other. Therefore, each of the p and q values of PHB 10 may be about 5.

Referring to FIG. 1, the following observations can be made from the NMR spectrum of PHB10 (i.e., the aromatic polyol of Preparative Examples A3). Firstly, the characteristic absorption peak of BHET oligomer (4.7 ppm) is not observed. Secondly, three major characteristic absorption peaks A (8 ppm, hydrogen of phenyl groups), B (4.6 ppm, hydrogen of terminal hydroxyl groups), and C [4.4 ppm, hydrogen of —C(O)—O—CH₂— group] were observed, and a ratio of the integrated peak areas thereof was calculated to be 4:2:4, which matches with a number of hydrogen attached to different structural parts of the aromatic polyol represented by Formula (I). Thirdly, the characteristic absorption peak of terminal hydroxyl groups of BHET monomer (5 ppm) represented by the formula of:

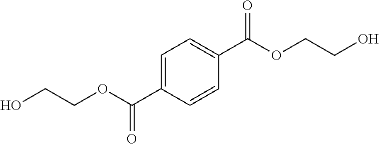 [SMILES: O=C(OCCO)c1ccc(C(=O)OCCO)cc1]

is not observed.

Therefore, it can be concluded that hydrogens originally attached to the terminal hydroxyl groups of BHET are separated from the phenyl group by —(O—CH₂—CH₂)ₚ— or —(CH₂—CH₂—O)_{q}— groups (i.e., the terminal segment of the aromatic polyol). The characteristic absorption peak of these hydrogens shifted to 4.6 ppm, which proves that BHET and EO can react to form the aromatic polyol represented by Formula (I).

### Preparation of Graphene Dispersion

The following Examples of the graphene dispersion were prepared with the aromatic polyols of Preparative Examples A2, A3, and A5.

### Example A1

(a) 97 g of the aromatic polyol of Preparative Example A2 (i.e., PHB6) was placed in a 250 mL beaker and stirred at 500 rpm using an electric mixer.

(b) Then, 3 g of an expanded graphite (purchased from Xuancheng Hengwang Co., Ltd; Product No: HW-POW-ZOOS) was added gradually into the beaker. Thereafter, the content of the beaker was stirred at 500 rpm using an electric mixer for one hour to obtain a mixed liquid.

(c) Next, the mixed liquid was placed and rolled in a three-roll mill (Manufacturer: Farn Chang Co., Ltd; Model: FC-90 mm made of tungsten steel). The rolling speed of the three-roll mill was set to be 50 m/s. During the rolling process, a space between each two adjacent ones of three rolls in the three-roll mill was set to be 10 μm, and a temperature of the three-roll mill was kept at 25° C. using a cooler condenser. After one hour of the rolling process, the mixed liquid was removed from the three-roll mill, thereby obtaining the graphene dispersion of Example A1. The time period of the rolling process may be extended, so as to ensure that the expanded graphite are completely transformed into graphene (i.e., a graphene conversion rate of at least 99%). Based on 3 g of the expanded graphite used in step b) and 97 g of the aromatic polyol of Preparative Example A2 (i.e., PHB6) used in step a), a solid content of the graphene in the graphene dispersion of Example A1 is calculated to be 3

$$wt \% [ = \frac{3}{( 3 + 97 )} \times 100 wt \% ] .$$

In addition, agglomeration is not observed in the graphene dispersion of Example A1, which indicates that the expanded graphite has been completely transformed into graphene, and that the graphene is effectively dispersed by the aromatic polyol.

### Examples A2 to A14

The procedures and conditions for preparing the graphene dispersions of Examples A2 to A14 were similar to those for preparing the graphene dispersion of Example A1, except that the aromatic polyol, the amount of aromatic polyol, and the amount of the expanded graphite used for preparing the graphene dispersion of each of Examples A2 to A14 were varied as listed in Table 4.

TABLE 4

| | | Amount of | Amount of | |
|---|---|---|---|---|
| | | aromatic | expanded | Solid content |
| | Aromatic | polyol used | graphite used | of graphene |
| Example | polyol | (g) | (g) | (wt %) |
| A1 | PHB6 | 97 | 3 | 3 |
| A2 | PHB10 | 97 | 3 | 3 |
| A3 | PHB20 | 97 | 3 | 3 |
| A4 | PHB6 | 95 | 5 | 5 |
| A5 | PHB10 | 95 | 5 | 5 |
| A6 | PHB20 | 95 | 5 | 5 |
| A7 | PHB6 | 93 | 7 | 7 |
| A8 | PHB10 | 93 | 7 | 7 |
| A9 | PHB20 | 93 | 7 | 7 |
| A10 | PHB6 | 91 | 9 | 9 |
| A11 | PHB10 | 91 | 9 | 9 |
| A12 | PHB20 | 91 | 9 | 9 |
| A13 | PHB10 | 99.03 | 0.97 | 0.97 |
| A14 | PHB20 | 99.03 | 0.97 | 0.97 |

### Comparative Examples 1 to 28

The graphene dispersion of each of Comparative Examples 1 to 28 was prepared under different procedures and conditions as summarized below. The reagent, the amount of the reagent, and the amount of the expanded graphite used for preparing the graphene dispersion of each of Comparative Examples 1 to 28 are listed in Table 5.

1. Preparation of Comparative Examples 1, 8, 15, and 22 [reagent: PEG1000 (polyethylene glycol, molecular weight: 1000 g/mol), purchased from Oriental Union Chemical Corporation]:

(a) A predetermined amount of PEG1000 was placed in a 250 mL beaker and heated at a temperature of 80° C. for 3 hours. After crystals of PEG1000 were completely melted, the content of the beaker was stirred at 500 rpm using an electric mixer.

(b) Then, the beaker was kept at 80° C., and a predetermined amount of the expanded graphite was gradually added into the beaker and stirred at 500 rpm for 1 hour using the electric mixer, so as to obtain a mixed liquid.

(c) Thereafter, the mixed liquid was rolled under the same procedures and conditions as those in step (c) of the preparation method of Example A1 to obtain the graphene dispersion, except that the cooler condenser was not used when the mixed liquid of each of Comparative Examples 1, 8, 15, and 22 was rolled. The solid content of graphene in the graphene dispersion of each of Comparative Examples 1, 8, 15, and 22 was calculated using the following formula:

$$\frac{Amount of expanded graphite}{Amount of expanded graphite + amount of reagent} \times 100 wt \%$$

(the premise is the graphene conversion rate is over 99% with the necessary, extended rolling process). The amounts of the PEG1000 and the expanded graphite for Comparative Examples 1, 8, 15, and 22 are listed in Table 5.

2. Preparation of Comparative Examples 2 to 6, 9 to 13, 16 to 20, and 23 to 27 [reagent: PPG1000 (polypropylene glycol, molecular weight: 1000 g/mol), PEG600 (polyethylene glycol, molecular weight: 600 g/mol), PPG600 (polypropylene glycol, molecular weight: 600 g/mol), PEG400 (polyethylene glycol, molecular weight: 400 g/mol), and PPG400 (polypropylene glycol, molecular weight: 400 g/mol), which were all purchased from Oriental Union Chemical Corporation):

(a) The reagent, in a predetermined amount, was placed in a 250 mL beaker and stirred at 500 rpm using an electric mixer. The reagents and amounts thereof for Comparative Examples 2 to 6, 9 to 13, 16 to 20, and 23 to 27 are listed in Table 5.

(b) Then, the expanded graphite, in a predetermined amount, was added into the beaker and mixed under the same procedures and conditions as those in step (b) of the preparation method of Example A1, except that the amounts of expanded graphite used for Comparative Examples 2 to 6, 9 to 13, 16 to 20, and 23 to 27 were varied as listed in Table 5.

(c) Thereafter, the thus obtained mixed liquid was rolled under the same procedures and conditions as those in step (c) of the preparation method of Example A1, so as to obtain the graphene dispersion. The solid content of graphene in the graphene dispersion of each of Comparative Examples 2 to 6, 9 to 13, 16 to 20, and 23 to 27 was calculated using the same formula as that of Comparative Examples 1, 8, 15, and 22.

3. Preparation of Comparative Examples 7, 14, 21, and 28 [reagent: propylene glycol monomethyl ether acetate (PGMEA), purchased from Emperor Chemical Co., Ltd.]:

(a) A predetermined amount of the reagent and 1 g of a dispersant (purchased from BYK; Product No: Disperbyk-108) were placed in a 250 mL beaker, and then the content of the beaker was stirred at 500 rpm using an electric mixer. Total amounts of the reagent and the dispersant for Comparative Examples 7, 14, 21, and 28 are listed in Table 5.

(b) Next, a predetermined amount of the expanded graphite was added into the beaker and mixed under the same procedures and conditions as those in step (b) of the preparation method of Example A1, except that the amounts of expanded graphite added for Comparative Examples 7, 14, 21, and 28 were varied as listed in Table 5.

(c) Thereafter, the thus obtained mixed liquid was rolled under the same procedures and conditions as those in step (c) of the preparation method of Example A1. The solid content of graphene in the graphene dispersion of each of Comparative Examples 7, 14, 21, and 28 was calculated using the following formula:

$$\frac{Amount of expanded graphite}{\begin{matrix}Amount of expanded graphite + \\ amount of reagent + amount of dispersant\end{matrix}} \times 100 wt \% .$$

TABLE 5

| | | Amount of | | |
|---|---|---|---|---|
| | Reagent/ | reagent/a | Amount of | Solid |
| | a combination | total amount | expanded | content of |
| Comparative | of reagent and | of reagent and | graphite | graphene |
| Example | dispersant | dispersant (g) | (g) | (wt %) |
| 1 | PEG1000 | 97 | 3 | 3 |
| 2 | PPG1000 | 97 | 3 | 3 |
| 3 | PEG600 | 97 | 3 | 3 |
| 4 | PPG600 | 97 | 3 | 3 |
| 5 | PEG400 | 97 | 3 | 3 |
| 6 | PPG400 | 97 | 3 | 3 |
| 7 | PGMEA + | 97 | 3 | 3 |
| | dispersant | | | |
| 8 | PEG1000 | 95 | 5 | 5 |
| 9 | PPG1000 | 95 | 5 | 5 |
| 10 | PEG600 | 95 | 5 | 5 |
| 11 | PPG600 | 95 | 5 | 5 |
| 12 | PEG400 | 95 | 5 | 5 |
| 13 | PPG400 | 95 | 5 | 5 |
| 14 | PGMEA + | 95 | 5 | 5 |
| | dispersant | | | |
| 15 | PEG1000 | 93 | 7 | 7 |
| 16 | PPG1000 | 93 | 7 | 7 |
| 17 | PEG600 | 93 | 7 | 7 |
| 18 | PPG600 | 93 | 7 | 7 |
| 19 | PEG400 | 93 | 7 | 7 |
| 20 | PPG400 | 93 | 7 | 7 |
| 21 | PGMEA + | 93 | 7 | 7 |
| | dispersant | | | |
| 22 | PEG1000 | 91 | 9 | 9 |
| 23 | PPG1000 | 91 | 9 | 9 |
| 24 | PEG600 | 91 | 9 | 9 |
| 25 | PPG600 | 91 | 9 | 9 |
| 26 | PEG400 | 91 | 9 | 9 |
| 27 | PPG400 | 91 | 9 | 9 |
| 28 | PGMEA + | 91 | 9 | 9 |
| | dispersant | | | |

Evaluations of the Graphene Dispersion:

1. Viscosity (cP):

The graphene dispersion of each of Examples A1 to A12 and Comparative Examples 1 to 28 was first kept still for a day, and then the viscosity thereof was determined by measuring with the digital viscometer (Brookfield DV-E) at 30° C. The results are presented in Table 6.

2. Dispersion Stability (Number of Days Passed Before Complete Sedimentation):

The dispersion stability of the graphene dispersion of each of Examples A1 to A12 and Comparative Examples 1 to 28 was determined as follows. First, the graphene dispersion was kept still and observed every 30 days until complete solid-liquid separation (i.e., sedimentation) therein was observed. The number of days passed since the start of the observation was recorded and presented in Table 6. Solid-liquid separation might not be observable for at least 150 days when the graphene dispersion has a viscosity of not less than 10000 cP.

3. Analysis of Particle Size:

The particle size of the graphene dispersion of each of Examples A1 to A12 and Comparative Examples 1 to 28 was determined as follows. First, the graphene dispersion and an alcohol were mixed at a volume ratio of 1:100 to obtain a test sample. Next, 5 mL of the test sample was placed in a centrifuge tube, and then the test sample was subjected to centrifugation using a centrifuge (Manufacturer: JR Science and Technology Application Co., Ltd; Model: LUMiSizer), after which was subjected to a fully automatic analysis using an analysis application. After 1 hour, a median diameter (D50, μm) of the sample was obtained. The results are listed in Table 6 below.

TABLE 6

| | | Aromatic polyol/ | Solid | Evaluations | | |
|---|---|---|---|---|---|---|
| | | reagent/a combination | content of | | Number of days passed | |
| | | of reagent and | graphene | Viscosity | before complete | D50 |
| | | dispersant | (wt %) | (cP) | sedimentation | (μm) |
| Example | A1 | PHB6 | 3 | 13000 | >150 days and ≤180 days | 1.3 |
| | A2 | PHB10 | 3 | 13500 | >150 days and ≤180 days | 1.5 |
| | A3 | PHB20 | 3 | 14230 | >150 days and ≤180 days | 1.7 |
| Comparative | 1 | PEG1000 | 3 | Solid¹ | Not observable² | 3.7 |
| Example | 2 | PPG1000 | 3 | 23000 | No sedimentation³ | 2.8 |
| | 3 | PEG600 | 3 | 25500 | No sedimentation³ | 3.5 |
| | 4 | PPG600 | 3 | 22000 | No sedimentation³ | 2.6 |
| | 5 | PEG400 | 3 | 24000 | No sedimentation³ | 3.3 |
| | 6 | PPG400 | 3 | 20500 | No sedimentation³ | 2.4 |
| | 7 | PGMEA + dispersant | 3 | 5000 | >60 days and ≤90 days | Not measured |
| Example | A4 | PHB6 | 5 | 17500 | >150 days and ≤180 days | 1.2 |
| | A5 | PHB10 | 5 | 18500 | No sedimentation³ | 1.4 |
| | A6 | PHB20 | 5 | 19500 | No sedimentation³ | 1.6 |
| Comparative | 8 | PEG1000 | 5 | Solid¹ | Not observable² | 3.6 |
| Example | 9 | PPG1000 | 5 | 28000 | No sedimentation³ | 2.7 |
| | 10 | PEG600 | 5 | 28000 | No sedimentation³ | 3.5 |
| | 11 | PPG600 | 5 | 25500 | No sedimentation³ | 2.5 |
| | 12 | PEG400 | 5 | 26500 | No sedimentation³ | 3.2 |
| | 13 | PPG400 | 5 | 24000 | No sedimentation³ | 2.3 |
| | 14 | PGMEA + dispersant | 5 | 7000 | >90 days and ≤120 days | Not measured |
| Example | A7 | PHB6 | 7 | 22000 | >150 days and ≤180 days | 1.1 |
| | A8 | PHB10 | 7 | 23500 | No sedimentation³ | 1.3 |
| | A9 | PHB20 | 7 | 24000 | No sedimentation³ | 1.5 |
| Comparative | 15 | PEG1000 | 7 | Solid¹ | Not observable² | 3.5 |
| Example | 16 | PPG1000 | 7 | 32500 | No sedimentation³ | 2.6 |
| | 17 | PEG600 | 7 | 34000 | No sedimentation³ | 3.4 |
| | 18 | PPG600 | 7 | 31000 | No sedimentation³ | 2.4 |
| | 19 | PEG400 | 7 | 31000 | No sedimentation³ | 3.1 |
| | 20 | PPG400 | 7 | 29500 | No sedimentation³ | 2.3 |
| | 21 | PGMEA + dispersant | 7 | 8500 | >120 days and ≤150 days | Not measured |
| Example | A10 | PHB6 | 9 | 26500 | >150 days and ≤180 days | 1.1 |
| | A11 | PHB10 | 9 | 29500 | No sedimentation³ | 1.3 |
| | A12 | PHB20 | 9 | 30500 | No sedimentation³ | 1.5 |
| Comparative | 22 | PEG1000 | 9 | Solid¹ | Not observable² | 3.5 |
| Example | 23 | PPG1000 | 9 | 36000 | No sedimentation³ | 2.5 |
| | 24 | PEG600 | 9 | 37500 | No sedimentation³ | 3.3 |
| | 25 | PPG600 | 9 | 34000 | No sedimentation³ | 2.4 |
| | 26 | PEG400 | 9 | 35500 | No sedimentation³ | 3.1 |
| | 27 | PPG400 | 9 | 32500 | No sedimentation³ | 2.2 |
| | 28 | PGMEA + dispersant | 9 | 10000 | >150 days and ≤180 days | Not measured |

¹The viscosity of the graphene dispersion is not measureable since the graphene dispersion is in a solid state under room temperature.
²Solid-liquid separation of the graphene dispersion is not observable since the graphene dispersion is in a solid state under room temperature.
³Sedimentation (i.e., solid-liquid separation) of the graphene dispersion is not observed after 180 days.

Discussion of Results Presented in Table 6:

1. Based on a comparison between Examples A1 to A3 and Comparative Examples 1 to 6, it can be seen that, while having the same solid content of graphene (3 wt %), the graphene dispersions of Examples A1 to A3 have viscosities higher than 10000 cP and lower than those of the graphene dispersions of Comparative Examples 1 to 6. Since the phenyl group in the aromatic polyol can prevent formation of π-π conjugation and intermolecular forces among graphene interlayers, the aromatic polyol may be more effective in dispersing graphene compared to other reagents and thus, the viscosity of the graphene dispersion may be reduced, which is advantageous for subsequent applications. Similarly, comparisons between the results of Examples A4 to A6 and Comparative Examples 8 to 13, between the results of Examples A7 to A9 and Comparative Examples 15 to 20, and between the results of Examples A10 to A12 and Comparative Examples 22 to 27 may lead to the same conclusion. In addition, the PEG1000 used in Comparative Examples 1, 8, 15, and 22 requires heating at 80° C. for 3 hours before use since PEG1000 crystallizes under room temperature. The resultant graphene dispersion would be in solid-state if the PEG1000 were not preheated, and therefore the manufacturing process of graphene dispersion with PEG1000 is more energy-consuming and less effective. Further, although the PGMEA used in Comparative Examples 7, 14, 21, and 28 can reduce the viscosity of the dispersant, too low viscosity may result in agglomeration and precipitation of the graphene in the graphene dispersion, and therefore the dispersion stability of the graphene dispersions of Comparative Examples 7, 14, 21, and 28 may be adversely affected after a long period of storage. Furthermore, heating is required when the graphene dispersions of Comparative Examples 7, 14, 21, and 28 are used in subsequent applications, so as to remove the PGMEA in the graphene dispersion, which complicates the manufacturing process and increases manufacturing cost thereof.

2. Sedimentation was not observed in the graphene dispersions of Examples A1 to A12 for at least 150 days, which indicates that the graphene dispersions of Examples A1 to A12 have outstanding dispersion stabilities in dispersing unmodified graphene, and may thus meet the requirements of a long period of storage.

3. The graphene dispersions of Examples A1 to A12 have relatively small particle sizes D50 (1.1 μm to 1.7 μm) than those of Comparative Examples 1 to 28 when the solid contents of graphene therein are the same. This indicates that the graphene dispersions of Examples A1 to A12 have better dispersing effects (i.e., less agglomeration). In addition, the smaller the particle size of the graphene dispersion, the better the properties thereof (e.g., electrical conductivity), which might be advantageous for subsequent applications.

4. Referring to the results in Comparison Table 1 below, based on a comparison among the aromatic polyols and the reagents having similar molecular weights, it can be concluded that the graphene dispersions made from the aromatic polyols have relatively low viscosities and smaller particle sizes compared to the graphene dispersions made from the conventional reagents. Taking a comparison among the graphene dispersions of Example A2, Comparative Example 3, and Comparative Example 4 as an example, the viscosity of the graphene dispersion of Example A2 (13500 cP) is clearly less than those of Comparative Example 3 (25500 cP) and Comparative Example 4 (22000 cP), and the D50 of the graphene dispersion of Example A2 (1.5 μm) is smaller than those of Comparative Example 3 (3.5 μm) and Comparative Example 4 (2.6 μm). Therefore, the graphene dispersions made from the aromatic polyols may exhibit better electrical conductivity and may improve convenience during use.

COMPARISON TABLE 1

| | Aromatic | Solid content | | |
|---|---|---|---|---|
| | polyol/ | of graphene | Viscosity | D50 |
| | reagent | (wt %) | (cP) | (μm) |
| Example A2 | PHB10 | 3 | 13500 | 1.5 |
| Comparative Example 3 | PEG600 | 3 | 25500 | 3.5 |
| Comparative Example 4 | PPG600 | 3 | 22000 | 2.6 |
| Example A3 | PHB20 | 3 | 14230 | 1.7 |
| Comparative Example 1 | PEG1000 | 3 | Solid | 3.7 |
| Comparative Example 2 | PPG1000 | 3 | 23000 | 2.8 |
| Example A5 | PHB10 | 5 | 18500 | 1.4 |
| Comparative Example 10 | PEG600 | 5 | 28000 | 3.5 |
| Comparative Example 11 | PPG600 | 5 | 25500 | 2.5 |
| Example A6 | PHB20 | 5 | 19500 | 1.6 |
| Comparative Example 8 | PEG1000 | 5 | Solid | 3.6 |
| Comparative Example 9 | PPG1000 | 5 | 28000 | 2.7 |
| Example A8 | PHB10 | 7 | 23500 | 1.3 |
| Comparative Example 17 | PEG600 | 7 | 34000 | 3.4 |
| Comparative Example 18 | PPG600 | 7 | 31000 | 2.4 |
| Example A9 | PHB20 | 7 | 24000 | 1.5 |
| Comparative Example 15 | PEG1000 | 7 | Solid | 3.5 |
| Comparative Example 16 | PPG1000 | 7 | 32500 | 2.6 |
| Example A11 | PHB10 | 9 | 29500 | 1.3 |
| Comparative Example 24 | PEG600 | 9 | 37500 | 3.3 |
| Comparative Example 25 | PEG600 | 9 | 34000 | 2.4 |
| Example A12 | PHB20 | 9 | 30500 | 1.5 |
| Comparative Example 22 | PEG1000 | 9 | Solid | 3.5 |
| Comparative Example 23 | PPG1000 | 9 | 36000 | 2.5 |

5. As shown in Comparison Table 1, the graphene dispersions of Examples A11 and A12 have relatively small D50 and viscosities within operable range. This indicates that the solid content of graphene may be further increased for subsequent applications. In fact, the graphene dispersion made from the aromatic polyols may still have a good fluidity even when the solid content of the graphene is raised to 18 wt %.

6. Referring to the results in Comparison Table 2 below, based on a comparison among the amounts of the TPA moiety and D50 of the graphene dispersions of Examples A1 to A3, it can be noted that with an increased amount of the TPA moiety (i.e., the hydrophobicity of the aromatic polyol increases due to an increased weight percentage of phenyl group (and 7E bonds)), formation of π-π bonds between the aromatic polyol and the graphene via conjugation may be increased and formation of intermolecular forces among graphene interlayers may be avoided, thereby increasing a dispersion stability of the graphene dispersion and decreasing the D50 thereof. The same conclusion can be made when comparing the graphene dispersions of Examples A4 to A6, A7 to A9, and A10 to A12.

COMPARISON TABLE 2

| | | | Solid | |
|---|---|---|---|---|
| | | | content of | |
| | Aromatic | Amount of TPA | graphene | D50 |
| Example | polyol | moiety (wt %) | (wt %) | (μm) |
| A1 | PHB6 | 32.0 | 3 | 1.3 |
| A2 | PHB10 | 24.0 | 3 | 1.5 |
| A3 | PHB20 | 14.6 | 3 | 1.7 |

7. Referring to the results in Comparison Table 3 below, based on a comparison among the solid contents of graphene and D50 of graphene dispersions of Examples A1, A4, A7, and A10, it can be concluded that with an increased solid content of the graphene (i.e., the viscosity of the graphene dispersion increases), a shearing strength imparted on the graphene dispersion may be increased during the rolling process using the three-roll mill to disperse and separate the agglomerated graphene or expanded graphene, and therefore the rolling process may be effective, thereby obtaining graphene dispersion with smaller D50. Similarly, comparisons among Examples A2, A5, A8, and A11, and among Examples A3, A6, A9, and A12 may lead to the same conclusion.

COMPARISON TABLE 3

| | | Solid content | |
|---|---|---|---|
| | Aromatic | of graphene | D50 |
| Example | polyol | (wt %) | (μm) |
| A1 | PHB6 | 3 | 1.3 |
| A4 | PHB6 | 5 | 1.2 |
| A7 | PHB6 | 7 | 1.1 |
| A10 | PHB6 | 9 | 1.1 |

### Preparation of Polyurethane Composite Material

### Application Examples 1 to 15 (AE1 to AE15), and Comparative

### Application Examples 1 to 25 (CAE1 to CAE25): PU Artificial Leather Including Solvent

100 g of a solvent-based one component polyurethane resin [purchased from Evermore Chemical Industry Co., Ltd.; Product No. SS-1054F; solid content of polyurethane: 30 wt %; solvent: dimethylformamide (DMF)] and a graphene dispersion were mixed, and then 1 g of a curing agent including isocyanate (purchased from Evermore Chemical Industry Co., Ltd.; Product No. SC-7190NY) was added and mixed well to obtain a composition for preparing the polyurethane composite material (hereinafter also referred as PU artificial leather). Next, the composition for preparing the PU artificial leather was spread on a release paper using a scraper to form a wet film having a thickness of approximately 60 μm, and then baked in an oven at 150° C. for 10 minutes, so as to remove the solvent (i.e., DMF), thereby obtaining the PU artificial leather having a thickness of 20 It should be noted that, in preparation of the PU artificial leathers of CAE8, CAE15, and CAE22, removal of PGMEA from the graphene dispersion is also required. In addition, the wet films of AE1, AE4, AE7, AE10, AE11 to AE15, and AE17, which were formed from the compositions including PHB20 (i.e., the graphene dispersion of Example A3), were required to be baked for a longer time (i.e., longer than 10 minutes) since E0 segments in PHB20 tend to absorb water. The graphene dispersion and the amount of the graphene dispersion used for preparing the PU artificial leather of each of AE1 to AE15 and CAE1 to CAE25 are presented in Table 7 below.

### Application Examples 16 and 17 (AE16 and AE17): PU Artificial Leather in Absence of Solvent Therein

25 g of a graphene dispersion and 0.1 g of 1,4-diazabicyclo[2.2.2]octane solution (purchased from Evonik; Product No. DABCO 33LV), which served as a catalyst, were stirred and mixed in a mixer at a rotation speed of 500 rpm for 1 minute to obtain a mixture. Then, the mixture and 7.25 g of methylene diphenyl diisocyanate (purchased from Harry Materials Association; Product No. PMDI 807B) were mixed in the mixer at a rotation speed of 2000 rpm for 30 seconds to obtain a composition for preparing the polyurethane composite material. Next, the composition for preparing the polyurethane composite material was spread on a release paper using a scraper with a 20 μm-wide slit, so as to form a wet film having a thickness of approximately 20 μm. Thereafter, the aromatic polyol in the graphene dispersion used for making the PU artificial leather was reacted with the methyl diphenyl diisocyanate for 5 minutes, thereby obtaining the PU artificial leather having a thickness of 20 μm. The graphene dispersion and the amount of the graphene dispersion used for preparing the PU artificial leather of each of AE16 and AE17 are presented in Table 7 below.

TABLE 7

| | | | | Aromatic polyol/ | | Solid content |
|---|---|---|---|---|---|---|
| | | | | reagent/a | Amount of | of graphene |
| | | | | combination of | graphene | in the PU |
| | | Graphene | | reagent and | dispersion | artificial |
| | | dispersion | | dispersant | used (g) | leather (wt %) |
| AE1 | | Example | A3 | PHB20 | 2.82 | 0.25 |
| CAE1 | | Comparative | 1 | PEG1000 | 2.82 | 0.25 |
| | | Example | | | | |
| AE | 2 | Example | A1 | PHB6 | 6.2 | 0.5 |
| | 3 | | A2 | PHB10 | 6.2 | 0.5 |
| | 4 | | A3 | PHB20 | 6.2 | 0.5 |
| CAE | 2 | Comparative | 1 | PEG1000 | 6.2 | 0.5 |
| | 3 | Example | 2 | PPG1000 | 6.2 | 0.5 |
| | 4 | | 3 | PEG600 | 6.2 | 0.5 |
| | 5 | | 4 | PPG600 | 6.2 | 0.5 |
| | 6 | | 5 | PEG400 | 6.2 | 0.5 |
| | 7 | | 6 | PPG400 | 6.2 | 0.5 |
| | 8 | | 7 | PGMEA + dispersant | 5.2 | 0.5 |
| AE | 5 | Example | A1 | PHB6 | 10.0 | 0.73 |
| | 6 | | A2 | PHB10 | 10.0 | 0.73 |
| | 7 | | A3 | PHB20 | 10.0 | 0.73 |
| CAE | 9 | Comparative | 1 | PEG1000 | 10.0 | 0.73 |
| | 10 | Example | 2 | PPG1000 | 10.0 | 0.73 |
| | 11 | | 3 | PEG600 | 10.0 | 0.73 |
| | 12 | | 4 | PPG600 | 10.0 | 0.73 |
| | 13 | | 5 | PEG400 | 10.0 | 0.73 |
| | 14 | | 6 | PPG400 | 10.0 | 0.73 |
| | 15 | | 7 | PGMEA + dispersant | 7.62 | 0.73 |
| AE | 8 | Example | A1 | PHB6 | 15.5 | 1.00 |
| | 9 | | A2 | PHB10 | 15.5 | 1.00 |
| | 10 | | A3 | PHB20 | 15.5 | 1.00 |
| CAE | 16 | Comparative | 1 | PEG1000 | 15.5 | 1.00 |
| | 17 | Example | 2 | PPG1000 | 15.5 | 1.00 |
| | 18 | | 3 | PEG600 | 15.5 | 1.00 |
| | 19 | | 4 | PPG600 | 15.5 | 1.00 |
| | 20 | | 5 | PEG400 | 15.5 | 1.00 |
| | 21 | | 6 | PPG400 | 15.5 | 1.00 |
| | 22 | | 7 | PGMEA + dispersant | 10.47 | 1.00 |
| AE | 11 | Example 9 | | PHB20 | 1.15 | 0.25 |
| | 12 | | | PHB20 | 2.38 | 0.50 |
| | 13 | | | PHB20 | 5.17 | 1.00 |
| | 14 | | | PHB20 | 8.45 | 1.50 |
| | 15 | | | PHB20 | 12.40 | 2.00 |
| CAE | 23 | Comparative | | PEG1000 | 1.15 | 0.25 |
| | 24 | Example 15 | | PEG1000 | 2.38 | 0.50 |
| | 25 | | | PEG1000 | 5.17 | 1.00 |

| | | | | | |
|---|---|---|---|---|---|
| AE | 16 | Example 13 | PHB10 | 25 | 0.75 |
| | 17 | Example 14 | PHB20 | 25 | 0.75 |

The solid contents of graphene in the PU artificial leathers in Table 7 were calculated using the following formulas:

1. For the PU Artificial Leather of Each of AE1 to AE17, CAE1 to CAE7, CAE9 to CAE14, CAE16 to CAE21, and CAE23 to CAE25:

theoretical solid content of graphene in the PU artificial leather=(amount of graphene dispersion×solid content of graphene in the graphene dispersion)/[(amount of PU resin used×solid content of PU)+amount of curing agent used+amount of graphene dispersion used]. It should be noted that the aromatic polyol, the polyethylene glycol, or the polypropylene glycol may react with the curing agent and may remain in the PU artificial leather.

2. For the PU Artificial Leather of Each of CAE8, CAE15, and CAE22:

theoretical solid content of graphene in the PU artificial leather=(amount of graphene dispersion×solid content of graphene in the graphene dispersion)/[(amount of PU resin used×solid content of PU)+amount of curing agent used+(amount of graphene dispersion×solid content of graphene in the graphene dispersion)+(amount of graphene dispersion used×weight percentage of dispersant in the graphene dispersion)], in which the weight percentage of dispersant in the graphene dispersion is 1 wt %.

### Evaluations of PU Artificial Leather:

The PU artificial leather of each of AE1 to AE17 and CAE1 to CAE25 was selectively evaluated for the following properties.

1. Surface Resistance (Ω/m²):

The surface resistance of the PU artificial leather of each of AE2 to AE10, AE16, AE17 and CAE2 to CAE22 was measured using a surface resistivity meter (Manufacturer: ACL Staticide Inc.; Model: ACL-380). The results are presented in Table 8.

2. Abrasion Resistance:

The abrasion resistance of the PU artificial leather of each of AE1, AE4, AE7, AE10, AE11 to AE15, CAE1, CAE2, CAE9, CAE16, and CAE23 to CAE25 was tested in an abrasion testing machine (Manufacturer: DACHANG INSTRUMENTS CO., LTD.; Model: QC-621B) with 600 g of steel wool (purchased from NIPPON STEEL WOOL Co., LTD., JAPAN; Product No. BON STAR No. 0000) for 30, 40, and 100 times. The abrasion resistance of a PU artificial leather is considered satisfactory (denoted as “∘”) if no damage is observed after the tests, and considered poor (denoted as “x”) if the PU artificial leather is damaged after the tests. The results are presented in Table 9.

3. Heat Dissipation Ability:

The PU artificial leather of each of AE11 to AE15 and CE23 to CE25 was tested for the following thermal properties. (1) A thermal diffusivity (mm²/s) was measured using a laser flash analyzer (Manufacturer: Erich NETZSCH GmbH & Co. Holding KG; Model: LFA 467 HyperFlash); (2) a specific heat (J/g° C.) was measured using a differential scanning calorimeter (Manufacturer: TechMax Technical Co., Ltd.; Model: DSC 7020); and (3) a density (g/cm³) was measured using a density meter (Manufacturer: Ivorist International Co., Ltd.; Model: DS 7800). A thermal conductivity (W/mK) of the PU artificial leather was then calculated using a formula of: thermal conductivity=thermal diffusivity×specific heat×density. The results are presented in Table 10.

TABLE 8

| | | Aromatic polyol/ | Solid content of | |
|---|---|---|---|---|
| | | reagent/a combination | graphene in the | Surface |
| | | of reagent | PU artificial | resistance |
| | | and dispersant | leather (wt %) | (Ω/m²) |
| AE | 2 | PHB6 | 0.5 | 10⁹ |
| | 3 | PHB10 | 0.5 | 10⁹ |
| | 4 | PHB20 | 0.5 | 10⁹ |
| CAE | 2 | PEG1000 | 0.5 | >10¹² |
| | 3 | PPG1000 | 0.5 | >10¹² |
| | 4 | PEG600 | 0.5 | >10¹² |
| | 5 | PPG600 | 0.5 | >10¹² |
| | 6 | PEG400 | 0.5 | >10¹² |
| | 7 | PPG400 | 0.5 | >10¹² |
| | 8 | PGMEA + dispersant | 0.5 | 10⁹ |
| AE | 5 | PHB6 | 0.73 | 10⁷ |
| | 6 | PHB10 | 0.73 | 10⁸ |
| | 7 | PHB20 | 0.73 | 10⁸ |
| CAE | 9 | PEG1000 | 0.73 | 10¹⁰ |
| | 10 | PPG1000 | 0.73 | 10¹¹ |
| | 11 | PEG600 | 0.73 | 10¹⁰ |
| | 12 | PPG600 | 0.73 | 10¹¹ |
| | 13 | PEG400 | 0.73 | 10¹⁰ |
| | 14 | PPG400 | 0.73 | 10¹¹ |
| | 15 | PGMEA + dispersant | 0.73 | 10⁸ |
| AE | 8 | PHB6 | 1.00 | 10⁷ |
| | 9 | PHB10 | 1.00 | 10⁷ |
| | 10 | PHB20 | 1.00 | 10⁷ |
| CAE | 16 | PEG1000 | 1.00 | 10⁹ |
| | 17 | PPG1000 | 1.00 | 10¹⁰ |
| | 18 | PEG600 | 1.00 | 10⁹ |
| | 19 | PPG600 | 1.00 | 10¹⁰ |
| | 20 | PEG400 | 1.00 | 10⁹ |
| | 21 | PPG400 | 1.00 | 10¹⁰ |
| | 22 | PGMEA + dispersant | 1.00 | 10⁷ |
| AE | 16 | PHB10 | 0.75 | 10⁸ |
| | 17 | PHB20 | 0.75 | 10⁸ |

### Discussion of Results Presented in Table 8:

When a PU artificial leather is made from a graphene dispersion having unsatisfactory dispersibility (e.g., agglomeration is observed), the agglomeration may adversely affect the electrical conductivity of the PU artificial leather, resulting in a relatively high surface resistance thereof. Taking the comparison between the PU artificial leathers of AE2 to AE4 and CAE2 to CAE8 as an example, it can be concluded that, when having the same solid content of graphene (i.e., 0.5 wt %) therein, the PU artificial leathers made from the graphene dispersions including the aromatic polyol (i.e., AE2 to AE4) exhibit relatively low surface resistances compared to the PU artificial leathers made from the graphene dispersions including other reagents without dispersant (i.e., CAE2 to CAE7). This result indicates that the graphene dispersions used to make the PU artificial leathers of AE2 to AE10 exhibit better dispersibility compared to that of other reagents. With a relatively low surface resistance, the PU artificial leather of this disclosure may be useful in antistatic applications.

It can also be seen that the PU artificial leathers of AE16 and AE17 have relatively low surface resistances, which indicate that the PU artificial leathers in absence of solvents therein exhibit satisfactory properties as well. In addition, since solvents were not required during the preparation processes of AE16 and AE17, each of the PU artificial leathers of AE16 and AE17 can be made simply by mixing the graphene dispersion including the aromatic polyol with the curing agent having isocyanate groups under room temperature (i.e., the heating step for removing the solvents can be omitted). Therefore, the process for preparing the PU artificial leathers in absence of solvents therein is environmentally friendly.

TABLE 9

| | | Amount of | Solid content of | | | |
|---|---|---|---|---|---|---|
| | Aromatic | graphene | graphene in the | Abrasion resistance | | |
| | polyol/ | dispersion | PU artificial | 100 | 40 | 30 |
| | reagent | (g) | leather (wt %) | tests | tests | tests |
| AE1 | PHB20 | 2.82 | 0.25 | ∘ | ∘ | ∘ |
| CAE1 | PEG1000 | 2.82 | 0.25 | x | x | ∘ |
| AE11 | PHB20 | 1.15 | 0.25 | ∘ | —^{a} | —^{a} |
| CAE23 | PEG1000 | 1.15 | 0.25 | x | —^{a} | —^{a} |
| AE4 | PHB20 | 6.2 | 0.5 | ∘ | ∘ | ∘ |
| CAE2 | PEG1000 | 6.2 | 0.5 | x | x | ∘ |
| AE12 | PHB20 | 2.38 | 0.5 | ∘ | —^{a} | —^{a} |
| CAE24 | PEG1000 | 2.38 | 0.5 | x | —^{a} | —^{a} |
| AE7 | PHB20 | 10.0 | 0.73 | ∘ | ∘ | ∘ |
| CAE9 | PEG1000 | 10.0 | 0.73 | x | x | ∘ |
| AE10 | PHB20 | 15.5 | 1.00 | ∘ | ∘ | ∘ |
| CAE16 | PEG1000 | 15.5 | 1.00 | x | x | ∘ |
| AE13 | PHB20 | 5.17 | 1.00 | ∘ | —^{a} | —^{a} |
| CAE25 | PEG1000 | 5.17 | 1.00 | x | —^{a} | —^{a} |
| AE14 | PHB20 | 8.45 | 1.50 | ∘ | —^{a} | —^{a} |
| AE15 | PHB20 | 12.40 | 2.00 | ∘ | —^{a} | —^{a} |

^{a}— stands for not measured

Discussion of Results Presented in Table 9:

As shown in Table 9, in groups having the same solid content of graphene (for example, AE1 and CAE1), the PU artificial leather of AE1 exhibits a higher abrasion resistance compared to that of CAE1. The graphene dispersion used to make the PU artificial leather of CAE1 was prepared from PEG1000, which has a relatively high hydrophilicity (due to the presence of PEG), and therefore the PU artificial leather of CAE1 tends to swell upon moisture absorption, resulting in an increase of viscosity at a surface thereof and adversely affecting abrasion resistance thereof. In comparison, no damage was observed on the PU artificial leather of AE1 after more than 200 abrasion tests. Similar conclusions can be made from comparison of the remaining groups in Table 9.

TABLE 10

| | | Solid content | | | | |
|---|---|---|---|---|---|---|
| | | of graphene in | | | | |
| | Aromatic | the PU | Thermal | Specific | | Thermal |
| | polyol/ | artificial | diffusivity | heat | Density | conductivity |
| | reagent | leather (wt %) | (mm²/s) | (J/g° C.) | (g/cm³) | (W/mK) |
| AE11 | PHB20 | 0.25 | 1.3 | 1.45 | 1.35 | 2.54 |
| CAE23 | PEG1000 | 0.25 | 0.11 | 1.47 | 1.35 | 0.22 |
| AE12 | PHB20 | 0.5 | 1.8 | 1.51 | 1.36 | 3.70 |
| CAE24 | PEG1000 | 0.5 | 0.17 | 1.54 | 1.36 | 0.36 |
| AE13 | PEG20 | 1.00 | 2.4 | 1.64 | 1.36 | 5.35 |
| CAE25 | PEG1000 | 1.00 | 0.21 | 1.66 | 1.35 | 0.47 |
| AE14 | PHB20 | 1.50 | 2.6 | 1.72 | 1.35 | 6.04 |
| AE15 | PHB20 | 2.00 | 2.6 | 1.8 | 1.36 | 6.36 |

Discussion of Results Presented in Table 10:

Taking the comparison between PU artificial leathers of AE11 and CAE23 as an example, it can be seen that in groups having the same solid content of graphene (for example, AE11 and CAE23), the PU artificial leather of AE11 has a significantly higher thermal conductivity than that of CAE23, indicating that the PU artificial leather of AE11 exhibits better heat dissipation ability than that of CAE23. Similar conclusions can be made from comparison of the remaining groups in Table 10. In addition, by comparing the thermal conductivities of the PU artificial leathers of AE11 to AE15, it can be concluded that the thermal conductivity (i.e., the heat dissipation ability) increases with an increased solid content of graphene in the PU artificial leather.

### Preparation of Modified Aromatic Polyol

### Preparative Examples B1 to B11 and Comparative Preparation Example B1

An aromatic polyol (i.e., Preparative Examples A2, A3, and A5 to A7) was mixed with an epoxidized soybean oil (purchased from Chang Chun Group; oxirane value: >6.6; acid value: <0.5 mgKOH/g; water content: <0.15%) to form a mixture. Then, the mixture was heated to a temperature of 160° C. and allowed to be reacted for 8 to 12 hours so as to obtain the modified aromatic polyol. The aromatic polyol, the amount of the aromatic polyol used, and the amount of the epoxidized soybean oil used for preparing the modified aromatic polyol of each of Preparative Examples B1 to B11 and Comparative Preparation Example B1 are presented in Table 11.

Subsequently, a viscosity of the modified aromatic polyol of each of Preparative Examples B1 to B11 and Comparative Preparation Example B1 was measured with the digital viscometer (Brookfield DV-E) at 30° C. In addition, a conversion ratio of the aromatic polyol transformed into the modified aromatic polyol of each of Preparative Examples B1 to B11 and Comparative Preparation Example B1 was calculated using the following formula:

$$conversion ratio = ( 1 - \frac{1}{\frac{EEW 2}{EEW 1}} ) \times 100 \% ,$$

wherein EEW2 is an epoxy equivalent weight of the modified aromatic polyol, and EEW1 is an epoxy equivalent weight of the mixture of Preparative Examples B1 to B4 or a theoretical epoxy equivalent weight required to react with the hydroxyl groups of the aromatic polyol of Preparative Examples B5 to B11 and Comparative Preparation Example B1. The results are presented in Table 11.

The abovementioned epoxy equivalent weights were determined with the following processes.

1. Preparation of Reagents:

1) 0.1 N Perchloric Acid-Acetic Acid Solution:

250 mL of glacial acetic acid, 4 mL of perchloric acid aqueous solution (concentration: 70 vol %), and 10.5 mL of acetic anhydride were added into a 500 mL volumetric flask in such order, followed by adding glacial acetic acid until the volumetric flask was completely filled. Thereafter, the volumetric flask was kept still for 4 hours, thereby obtaining a 0.1 N perchloric acid-acetic acid solution.

2) 0.1 Vol % Indicator:

0.02 g of crystal violet (purchased from sigma aldrich) was dissolved in 20 mL of glacial acetic acid to obtain a 0.1 vol % indicator.

3) 25 w/v % Tetraethylammonium Bromide (TEAB) Reagent:

25 g of TEAB (purchased from sigma aldrich) was dissolved in 100 mL of glacial acetic acid to obtain a 25 w/v % TEAB reagent.

2. Measurement of Epoxy Equivalent Weight:

0.4 g to 2.5 g of a test sample (i.e., the modified aromatic polyol) was dissolved in 10 mL of chloroform, and then 0.5 mL of the 0.1 vol % indicator and 10 mL of the TEAB reagent were added to obtain a mixed liquid. Thereafter, the mixed liquid was titrated with the 0.1 N perchloric acid-acetic acid solution until the originally purple-colored mixed liquid turned green. The amount V1 (mL) of the perchloric acid-acetic acid solution used during the titration process was recorded. A control test was also conducted with a test liquid obtained by mixing 0.5 mL of the indicator, 10 mL of the TEAB reagent, and 10 mL of chloroform. The test liquid was also titrated with the perchloric acid-acetic acid solution, and an amount V0 (mL) of the perchloric acid-acetic acid solution used during the titration was recorded. The epoxy equivalent weight was then calculated using a formula of:

$$\frac{M}{( V 1 - V 0 ) \times 0.1 N} ,$$

in which M is a weight of the test sample.

TABLE 11

| | | Amount of | Amount of | | |
|---|---|---|---|---|---|
| | | aromatic | epoxidized | | |
| | | polyol used | soybean oil | | Viscosity |
| | Aromatic | (parts by | used (parts by | Conversion | at 30° C. |
| | polyol | weight) | weight) | ratio (%) | (cP) |
| Preparative | PHB20 | 100 | 0 | — | 1062 |
| Example A5 | | | | | |
| Preparative | PHB20 | 100 | 5 | 99.5 | 1135 |
| Example B1 | | | | | |
| Preparative | PHB20 | 100 | 10 | 95.1 | 1220 |
| Example B2 | | | | | |
| Preparative | PHB20 | 100 | 20 | 91.3 | 1285 |
| Example B3 | | | | | |
| Preparative | PHB20 | 100 | 40 | 92.5 | 1311 |
| Example B4 | | | | | |
| Preparative | PHB20 | 100 | 80 | 92.1 | 1355 |
| Example B5 | | | | | |
| Preparative | PHB20 | 100 | 100 | 91.8 | 1386 |
| Example B6 | | | | | |
| Preparative | PHB20 | 100 | 150 | 95.5 | 1405 |
| Example B7 | | | | | |
| Comparative | PHB20 | 100 | 200 | 93.0 | 1395 |
| Preparation | | | | | |
| Example B1 | | | | | |
| Preparative | PHB6 | 100 | 80 | 90.4 | 465 |
| Example B8 | | | | | |
| Preparative | PHB10 | 100 | 80 | 94.6 | 576 |
| Example B9 | | | | | |
| Preparative | PHB25 | 100 | 80 | 95.7 | 1425 |
| Example B10 | | | | | |
| Preparative | PHB30 | 100 | 80 | 93.5 | 1489 |
| Example B11 | | | | | |

Evaluations of the Modified Aromatic Polyol:

The aromatic polyol of Preparative Example A5, the modified aromatic polyol of each of Preparative Examples B1 to B11, and Comparative Example B1 were evaluated for the following properties. The results are presented in Table 12 below.

1. Initial Water Content (%):

The initial water content of each of the aromatic polyol and modified aromatic polyols was measured using an autotitrator (Manufacturer: Metrohm AG; Model: 888 Titrando) and a Karl Fischer reagent (purchased from Fluka Chemical Corp; Item No.: HYDRANAL®—Composite 5) according to Karl Fischer titration methods.

2. Water Content after Storage (%):

Each of the aromatic polyol and modified aromatic polyols was stored at an ambient humidity of 85 RH % and a temperature of 25° C. for 1 month, 2 months, or 3 months, and then the water content of each of the aromatic polyol and modified aromatic polyols was measured after 1 month, 2 months, and 3 months of storage following the abovementioned procedures for measuring the initial water content thereof.

3. Acid Value (mgKOH/g):

Each of the aromatic polyol and modified aromatic polyols was stored at an ambient humidity of 85 RH % and a temperature of 25° C. for 1 month to form a reaction liquid, and the reaction liquid was subjected to the following tests for determining an acid value thereof.

(1) Preparation and Calibration of 0.01 N NaOH Aqueous Solution:

10 mL of a 1 N NaOH aqueous solution was placed in a 1 L volumetric flask, and then deionized water was added until the volumetric flask was completely filled, thereby obtaining a 0.01 N NaOH aqueous solution. Thereafter, the NaOH aqueous solution was titrated using the autotitrator (Metrohm 888 Titrando) and a potassium biphthalate (KHP) solution (obtained by mixing 0.018 g of KHP with 20 g of deionized water and then with 30 g of acetone). A volume of the NaOH aqueous solution at a titration end point was recorded, and an actual concentration of the NaOH aqueous solution after calibration was calculated using the following formula:

$$actual concentration of NaOH aqueous solution = \frac{Weight of KPH ( g )}{0.20422 \times volume of NaOH aqueous solution ( mL )} ,$$

in which the volume of the NaOH aqueous solution is the recorded volume at the titration end point.

(2) Determination of Acid Value:

An adequate amount of the reaction liquid (i.e., each of the aromatic polyol and modified aromatic polyols after 1 month of storage) was dissolved in 50 g of a solvent (a mixed liquid of acetone and methanol at a volume ratio of 1:1) to obtain a test liquid. Then, another 50 g of the solvent was placed in a container to serve as a control group. Thereafter, each of the test liquid and the control group was titrated with the 0.01 N NaOH aqueous solution. An amount Vₛ (mL) of the NaOH aqueous solution used for titrating the test liquid and an amount V_{b} (mL) of the NaOH aqueous solution used for titrating the control group were recorded. Finally, an acid value was calculated using the following formula:

$$acid value = \frac{( {V}_{S} - {V}_{b} ) \times N \times 56.1}{W} ,$$

in which N is the actual concentration (N) of the NaOH aqueous solution after calibration, and W is a total weight (g) of the test liquid.

TABLE 12

| | | | Amount of | | Initial | Water content after storage | | |
|---|---|---|---|---|---|---|---|---|
| | | | epoxidized | | water | (85 RH %, 25° C.) | | |
| | | Aromatic | soybean oil used | Acid value | content | 1 | 2 | 3 |
| | | polyol | (parts by weight) | (mgKOH/g) | (%) | month | months | months |
| Preparative Example A5 | | PHB20 | 0 | 1.2 | 0.15 | 10.1 | 15.7 | 16.7 |
| Preparative | B1 | PHB20 | 5 | 0.9 | 0.11 | 2.7 | 3.1 | 5.7 |
| Example | B2 | PHB20 | 10 | 0.9 | 0.09 | 2.6 | 2.9 | 4.4 |
| | B3 | PHB20 | 20 | 0.8 | 0.11 | 1.9 | 2.5 | 3.7 |
| | B4 | PHB20 | 40 | 0.7 | 0.1 | 0.85 | 1.2 | 1.7 |
| | B5 | PHB20 | 80 | 0.4 | 0.1 | 0.5 | 0.56 | 0.61 |
| | B6 | PHB20 | 100 | 0.4 | 0.09 | 0.3 | 0.33 | 0.35 |
| | B7 | PHB20 | 150 | 0.2 | 0.08 | 0.2 | 0.25 | 0.27 |
| Comparative | B1 | PHB20 | 200 | 0.1 | 0.08 | 0.19 | 0.22 | 0.25 |
| Preparation Example | | | | | | | | |
| Preparative | B8 | PHB6 | 80 | 0.5 | 0.09 | 0.41 | 0.47 | 0.56 |
| Example | B9 | PHB10 | 80 | 0.4 | 0.1 | 0.44 | 0.51 | 0.64 |
| | B10 | PHB25 | 80 | 0.5 | 0.09 | 0.37 | 0.49 | 0.67 |
| | B11 | PHB30 | 80 | 0.4 | 0.07 | 0.66 | 0.71 | 0.75 |

### Discussion of Results Presented in Table 12:

1. Taking a comparison between the aromatic polyol of Preparative Example A5 and the modified aromatic polyol of Preparative Example B1 that, it can be observed that while the water content of the modified aromatic polyol of Preparative Example B1 increased by 2.59% from the initial water content of 0.11% to 2.7% after 1 month of storage, the water content of the aromatic polyol of Preparative Example A5 increased by 9.95% from the initial water content of 0.15% to 10.1% after 1 month of storage. This result indicates that the modified aromatic polyol exhibits a higher resistance to water absorption. In particular, the modified aromatic polyol has a relatively low initial water content, a slower increase of water content, and can maintain a water content of not greater than 5% after 2 months of storage.

2. A comparison among the initial water contents and water contents after 1 month of storage of the modified aromatic polyols of Preparative Examples B1 to B7 was made and the results are presented in Comparison Table 4 below. The results show that an increased amount of the water content decreases with an increased amount of the epoxidized soybean oil used. Therefore, it is proven that a lower water content can be achieved by modifying the amount of the aromatic polyol using the epoxidized soybean oil.

TABLE 4
Comparison

| | Preparative Example | | | | | | |
|---|---|---|---|---|---|---|---|
| | B1 | B2 | B3 | B4 | B5 | B6 | B7 |
| Amount of epoxidized | 5 | 10 | 20 | 40 | 80 | 100 | 150 |
| soybean oil used (parts | | | | | | | |
| by weight) | | | | | | | |
| Initial water content | 0.11 | 0.09 | 0.11 | 0.1 | 0.1 | 0.09 | 0.08 |
| (%) | | | | | | | |
| Water content after 1 | 2.7 | 2.6 | 1.9 | 0.85 | 0.5 | 0.3 | 0.2 |
| month of storage (%) | | | | | | | |
| Increase of water | 2.59 | 2.51 | 1.79 | 0.75 | 0.4 | 0.21 | 0.12 |
| content (%)¹ | | | | | | | |

¹Increase of water content = water content after 1 month of storage − initial water content.

3. A comparison among the modified aromatic polyols of Preparative Examples B5 and B8 to B11, which were prepared using the same amount of the epoxidized soybean oil (80 parts by weight), was made and the results are presented in Comparison Table 5 below. The results show that the modified aromatic polyols can maintain a water content of lower than 1% after 3 months of storage even when prepared from aromatic polyols having relatively long E0 segments (e.g., PHB20, PHB25, and PHB30). Therefore, it is proven that the modified aromatic polyol can be stored for a relatively long period of time while maintaining a relatively low water content.

| | COMPARISON TABLE 5 | | | | |
|---|---|---|---|---|---|
| | Preparative Example | | | | |
| | B8 | B9 | B5 | B10 | B11 |
| Aromatic polyol | PHB6 | PHB10 | PHB20 | PHB25 | PHB30 |
| Initial water content (%) | 0.09 | 0.1 | 0.1 | 0.09 | 0.07 |
| Water content after 1 | 0.41 | 0.44 | 0.5 | 0.37 | 0.66 |
| month of storage (%) | | | | | |
| Water content after 2 | 0.47 | 0.51 | 0.56 | 0.49 | 0.71 |
| months of storage (%) | | | | | |
| Water content after 3 | 0.56 | 0.64 | 0.61 | 0.67 | 0.75 |
| months of storage (%) | | | | | |

4. As shown in Table 12, the acid value of each of the aromatic polyol and modified aromatic polyol decreases with an increased amount of the epoxidized soybean oil used.

### Preparation of Graphene Dispersion Including Modified Aromatic Polyol

### Examples B1 to B11 and Comparative Example B1

The procedures and conditions for preparing the graphene dispersion of Examples B1 to B11 and Comparative Example B1 were similar to those for preparing the graphene dispersion of Example A3, except that modified aromatic polyols were used instead of PHB20, and that the amounts of epoxidized soybean oil used to modify the aromatic polyols were varied as shown in Table 13. The graphene dispersion of each of Examples B1 to B11 and Comparative Example B1 was prepared by using 97 g of modified aromatic polyol and 3 g of expanded graphite, and the solid content of graphene in the graphene dispersion can be as high as 3 wt %.

The amount of TPA moiety of the modified aromatic polyol used for preparing the graphene dispersion of each of Examples B1 to B11 and Comparative Example B1 was evaluated according to the abovementioned procedures and conditions for evaluating the amount of TPA moiety of the aromatic polyol of each of Preparative Examples A1 to A7. The viscosity and the dispersion stability of the graphene dispersion of each of Examples B1 to B11 and Comparative Example B1 were evaluated according to the abovementioned procedures and conditions for evaluating the graphene dispersion of each of Examples A1 to A12. The viscosity was tested after the graphene dispersion was left to stand for 1 day. The results are presented in Table 13.

TABLE 13

| | Modified aromatic polyol | | | Amount of TPA | |
|---|---|---|---|---|---|
| | | Amount of | Viscosity at | moiety of | |
| | Aromatic | epoxidized | 30° C. (left | modified | |
| | polyol | soybean oil used | to stand for 1 | aromatic polyol | Days required for |
| | used¹ | (parts by weight) | day) (cP) | (wt %) | complete sedimentation |
| Example A3 | PHB20 | 0 | 14230 | 14.6 | >150 days and ≤180 days |
| Example B1 | PHB20 | 5 | 15117 | 13.9 | >180 days and ≤210 days |
| Example B2 | PHB20 | 10 | 15647 | 13.2 | >210 days and ≤240 days |
| Example B3 | PHB20 | 20 | 16450 | 12.1 | No sedimentation² |
| Example B4 | PHB20 | 40 | 18475 | 10.4 | No sedimentation² |
| Example B5 | PHB20 | 80 | 20005 | 8.1 | No sedimentation² |
| Example B6 | PHB20 | 100 | 20146 | 7.4 | No sedimentation² |
| Example B7 | PHB20 | 150 | 19045 | 5.8 | No sedimentation² |
| Comparative | PHB20 | 200 | 19648 | 4.8 | ≤7 days |
| Example B1 | | | | | |
| Example B8 | PHB6 | 80 | 5005 | 17.6 | No sedimentation² |
| Example B9 | PHB10 | 80 | 8450 | 13.2 | No sedimentation² |
| Example B10 | PHB25 | 80 | 21746 | 6.8 | No sedimentation² |
| Example B11 | PHB30 | 80 | 24690 | 5.8 | No sedimentation² |

¹The amount of the aromatic polyol used was 100 parts by weight.
²Sedimentation (i.e., solid-liquid separation) of the graphene dispersion was not observed for over 240 days.

### Discussion of Results Presented in Table 13:

As shown in Table 13, sedimentation (i.e., solid-liquid separation) was not observed for approximately 180 days in the graphene dispersion of Example A3 (made from unmodified PHB20). In comparison, no sedimentation was observed for more than 180 days (e.g., at least 240 days) in the graphene dispersions of Examples B1 to B7, which were made from PHB20 modified with the epoxidized soybean oil. This result indicates that the epoxidized soybean oil is effective in reducing water absorbed by long EO segments in PHB20, which may increase the dispersion stability of the graphene dispersion made from the modified aromatic polyol.

In addition, the graphene dispersion of Comparative Example B1 exhibits a low dispersion stability since the modified aromatic polyol used to prepare the graphene dispersion of Comparative Example B1 includes a relatively high amount of the epoxidized soybean oil (i.e., 200 parts by weight), which resulted in a relatively low weight percentage of TPA moiety in the graphene dispersion (i.e., lower than 5 wt %). When the amount of TPA moiety in the graphene dispersion is lower than 5 wt %, the aromatic polyol or modified aromatic polyol might not be able to effectively form π-π conjugation with graphene, resulting in solid-liquid separation within 7 days of storage under room temperature.

Therefore, it can be concluded that the amount of epoxidized soybean oil used for preparing the graphene dispersion should be within a range of 5 parts by weight to 150 parts by weight, so that the modified aromatic polyol has a satisfactory water content, and solid-liquid separation of the graphene dispersion caused by water absorption can be avoided.

### Application Example B1

A composition for making the PU artificial leather of Application Example B1 was similar to those for making the PU artificial leathers of AE1 to AE15, except that the graphene dispersion of Example B1 was used instead of the graphene dispersions of Examples A1 to A15. The compositions for making the PU artificial leathers of AE7 and Application Example B1 were spread on two release papers to form two wet films (each having a thickness of approximately 60 μm) and then the wet films were baked at 150° C. until stickiness thereof was lost, thereby obtaining the PU artificial leathers of AE7 and Application Example B1. The theoretical solid content of graphene in the PU artificial leather of Application Example B1 was calculated in a manner similar to those for calculating the theoretical solid content of the graphene in the PU artificial leathers of AE1 to AE 17, and was determined to be 0.73%. In addition, the surface resistances of the PU artificial leathers of AE7 and Application Example B1 were also measured. The results were presented in Table 14 below.

TABLE 14

| | | Surface |
|---|---|---|
| | Graphene | resistance |
| | dispersion | (Ω/m²) |
| AE7 | Example A3 | 10⁸ |
| Application Example B1 | Example B1 | 10⁸ |

### Discussion of Results Presented in Table 14:

The results show that the surface resistance of the PU artificial leather of AE7 (made from the graphene dispersion of Example A3) is the same as that of Application Example B1 (made from the graphene dispersion of Example B1), and therefore both the aromatic polyol and the modified aromatic polyol can effectively disperse unmodified graphene (i.e., a source of graphene such as graphene powder or graphene sheet that is not required to be additionally treated to achieve an improved dispersibility), and the PU artificial leathers of AE7 and Application Example B1 may both exhibit satisfactory electrical properties in subsequent applications.

In sum, by virtue of the aromatic polyol represented by Formula (I), and the modified aromatic polyol made by subjecting the aromatic polyol represented by Formula (I) and the epoxidized vegetable oil to a ring opening reaction, the graphene dispersion of this disclosure may exhibit a satisfactory dispersion stability, and the PU artificial leather made from the graphene dispersion may exhibit improved abrasion resistance and electrical properties (e.g., antistatic property).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A graphene dispersion, comprising:
a graphene; and
a polyol compound selected from the group consisting of an aromatic polyol represented by Formula (I), and a modified aromatic polyol made by subjecting said aromatic polyol represented by Formula (I) and an epoxidized vegetable oil to a ring opening reaction, 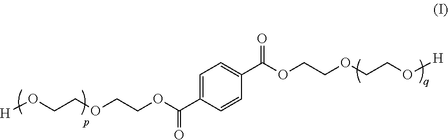
wherein
p and q are independently integers ranging from 1 to 20.

2. The graphene dispersion according to claim 1, wherein said graphene is present in an amount ranging from 1 wt % to 20 wt % based on a total weight of said graphene dispersion.

3. The graphene dispersion according to claim 1, wherein said epoxidized vegetable oil is selected from the group consisting of epoxidized soybean oil, epoxidized sunflower oil, epoxidized olive oil, epoxidized corn oil, epoxidized peanut oil, epoxidized canola oil, and combinations thereof.

4. The graphene dispersion according to claim 1, wherein said polyol compound is said modified aromatic polyol, which has a moiety represented by Formula (II) that is present in an amount ranging from 5 wt % to 18 wt % based on a total weight of said modified aromatic polyol

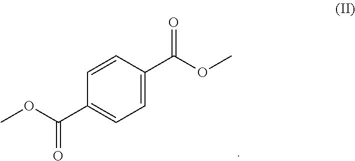

5. The graphene dispersion according to claim 1, in which said graphene is unmodified.

6. A method for preparing a graphene dispersion, comprising the steps of:
a) mixing an expanded graphite and a polyol compound to obtain a mixture, the polyol compound being selected from the group consisting of an aromatic polyol represented by Formula (I) and a modified aromatic polyol made by subjecting the aromatic polyol represented by Formula (I) and an epoxidized vegetable oil to a ring opening reaction, 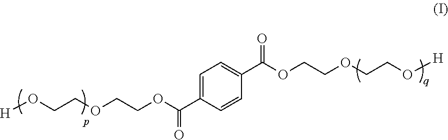
in which p and q are independently integers ranging from 1 to 20; and
b) subjecting the mixture to a mechanical process so as to exfoliate the expanded graphite to obtain the graphene dispersion.

7. The method according to claim 6, before step a), further comprising a step of
a1) reacting bis(2-hydroxyethyl) terephthalate with ethylene oxide to obtain the aromatic polyol represented by Formula (I).

8. The method according to claim 7, wherein, in step a1), a ratio of a molar amount of the ethylene oxide to a molar amount of the bis(2-hydroxyethyl) terephthalate is not smaller than 4.

9. The method according to claim 6, wherein the epoxidized vegetable oil is selected from the group consisting of epoxidized soybean oil, epoxidized sunflower oil, epoxidized olive oil, epoxidized corn oil, epoxidized peanut oil, epoxidized canola oil, and combinations thereof.

10. The method according to claim 6, wherein, in step a), the polyol compound is the modified aromatic polyol, and the amount of the epoxidized vegetable oil used ranges from 5 parts by weight to 150 parts by weight based on 100 parts by weight of the aromatic polyol used.

11. The method according to claim 6, wherein the mechanical process is selected from the group consisting of mechanical exfoliation, ultrasonic exfoliation, three roll milling, ball mill mixing, shear mixing, high speed homogenizing, high pressure homogenizing, and combinations thereof.

12. A composition for preparing a polyurethane composite material, comprising:
said graphene dispersion according to claim 1; and
a curing compound having at least two isocyanate groups.

13. The composition according to claim 12, wherein said graphene is present in an amount ranging from 1 wt % to 20 wt % based on a total weight of said graphene dispersion.

14. The composition according to claim 12, further comprising a polyurethane which is in the absence of a solvent therein.

15. The composition according to claim 14, wherein an amount of said graphene dispersion ranges from 1 parts by weight to 20 parts by weight based on 30 parts by weight of said polyurethane.

16. The composition according to claim 12, further comprising a polyurethane slurry including a polyurethane and a solvent.

17. The composition according to claim 16, wherein an amount of said graphene dispersion ranges from 1 parts by weight to 20 parts by weight based on 30 parts by weight of said polyurethane in said polyurethane slurry.

18. The composition according to claim 12, which is in the absence of a solvent therein.

19. A polyurethane composite material made from a composition according to claim 12.
